(19) United States
(12) Patent Application Publication
(10) Pub. No.: US 2026/0159149 A1
(43) Pub. Date: Jun. 11, 2026

(54) STEERING WHEEL

(71) Applicant: Autoliv Development AB, Vargarda (SE)

(72) Inventors: Liang DING, Shanghai (CN); Linlin XU, Shanghai (CN)

(21) Appl. No.: 18/723,734

(22) PCT Filed: Sep. 8, 2022
(86) PCT No.: PCT/CN2022/117805

§ 371 Date: Jun. 24, 2024

(30) Foreign Application Priority Data
Dec. 29, 2021 (CN) 202123446051.1

(51) Int. Cl. B62D 1/06; B60R 21/203

(52) U.S. Cl. CPC B62D 1/06; B60R 21/203

(57) ABSTRACT

A steering wheel is provided. The steering wheel is used for a vehicle, and comprises: a steering wheel central portion and a steering wheel rim surrounding the steering wheel central portion. The steering wheel central portion comprises a cover and a support. The cover is connected to the support in a suspended manner, and the cover and the support together define an installation space in which a functional module is arranged, wherein a predetermined function provided in the functional module can be enabled/disabled by touching the cover, the cover is a seamless cover, and the support is an integrated support.

### TECHNICAL FIELD

The present invention relates to accessories for vehicles, and relates in particular to a steering wheel.

### BACKGROUND

With the rapid development of vehicle technology, the intelligence of vehicles has become an important direction of development. The functions of vehicles are also increasing accordingly, and these functions are enabled or disabled by switch buttons. Switch buttons commonly used in vehicles are classified into two types: one type being touch switch buttons, and the other type being mechanical switch buttons. Mechanical switch buttons are very mature, but can provide only limited functions, and therefore cannot be used in high-end intelligent vehicles. Touch switch buttons typically need to be used together with a component that prevents unintentional touches, so as to prevent an unintentional operation.

In addition, a horn assembly is also mounted in vehicles. While a vehicle is traveling, a driver may enable the horn assembly as desired (e.g., in order to alert a pedestrian in front of the vehicle) to emit a sound signal. An operation of enabling the horn assembly is for the driver to press the steering wheel to move a safety airbag device downwards to close a circuit of the horn assembly, so as to emit a sound signal. Alternatively, the horn function is similarly enabled by a touch switch button.

Since the steering wheel has touch switch buttons integrated on a cover thereof, when a driver touches a touch switch button arranged on the cover to enable/disable a corresponding function, the cover may wobble due to the force applied by the driver, or the strength of a member used for supporting may be insufficient and thus cause damage.

Therefore, it is desirable to provide a steering wheel that is stable and reliable when subjected to force.

### SUMMARY

The objective of the present invention is to provide a steering wheel that is stable and reliable when subjected to a force. In particular, the cover of the steering wheel is stably supported without wobbling when touched by a driver to enable/disable a corresponding function by means of a touch switch, and the strength of a member for supporting is sufficient without causing the cover to be damaged.

The present invention provides a steering wheel. The steering wheel is used for a vehicle and comprises:
a steering wheel central portion and a steering wheel rim surrounding the steering wheel central portion, the steering wheel central portion comprising a cover and a support, the cover being connected to the support in a suspended manner, and the cover and the support together defining an installation space in which a functional module is arranged, wherein a predetermined function provided in the functional module can be enabled/disabled by touching the cover,
wherein,
the cover is a seamless cover, and the support is an integrated support.

According to an embodiment of the present invention, elastic units are provided between the cover and the support.

According to an embodiment of the present invention, the cover is divided into a middle region, and a first side region and a second side region located on both sides of the middle region, the functional module is provided at a portion of the support corresponding to the first side region or the second side region, and an airbag module is provided at a portion of the support corresponding to the middle region.

According to an embodiment of the present invention, the steering wheel further comprises a steering wheel body which is fixed to the steering wheel rim by means of spokes,
the steering wheel central portion further comprises a connecting plate and a rear cover located between the support and the steering wheel body, the support is fixed to the connecting plate by means of a first fixing member at the portion in which the airbag module is provided, the connecting plate is fixed to the steering wheel body, and
the support is connected to the rear cover by means of a second fixing member at the portion in which the functional module is provided, and the rear cover is fixed to a foam body of the steering wheel rim.

According to an embodiment of the present invention, the first fixing member is provided as a bolt-and-nut assembly and the second fixing member is provided as a screw.

According to an embodiment of the present invention, the rear cover is provided with mushroom-shaped protrusions for fixing into the foam body.

According to an embodiment of the present invention, the support is provided with hook-shaped portions, and the hook-shaped portions are provided to extend into a window portion of the cover so that the cover is snapped on the support.

According to an embodiment of the present invention, the functional module comprises touch feedback modules, and the touch feedback modules comprise a vibration feedback device provided on the cover for providing vibration feedback when the predetermined function is enabled/disabled.

According to an embodiment of the present invention, the elastic units are configured as a plurality of pieces of rubber distributed on both a portion of the support corresponding to the first side region and a portion of the support corresponding to the second side region.

According to an embodiment of the present invention, the functional module comprises printed circuit boards fixed to the support; force sensors are provided on the printed circuit boards to detect the position and/or the magnitude of a touch force applied to the cover; the predetermined function comprises one or more among a horn function, a multimedia function, and an auto-cruise function; and the predetermined function of the functional module is enabled/disabled on the basis of the position and/or the magnitude of the touch force detected by the force sensor.

### BRIEF DESCRIPTION OF THE DRAWINGS

The features, advantages, and technical effects of exemplary embodiments of the present invention will be described below with reference to the accompanying drawings. In the accompanying drawings, the same reference numbers denote the same elements, where

FIG. 1 schematically illustrates, in the front view, a steering wheel according to an embodiment of the present invention.

FIG. 2 schematically illustrates, in an exploded view, the steering wheel according to the embodiment of the present invention.

FIG. 3 schematically illustrates a support in the steering wheel according to the embodiment of the present invention.

### DETAILED DESCRIPTION

Specific implementations of a steering wheel according to the present invention will be described below with reference to the accompanying drawings. The following detailed description and the accompanying drawings are used to illustratively explain the principles of the present invention. The present invention is not limited to the described preferred embodiments, and various embodiments described in the present invention can be used individually or in any combination. The scope of protection of the present invention is defined by the claims.

In addition, terms for spatial relations (such as “upper”, “lower”, “left”, “right”, etc.) are used to describe a relative positional relationship between an element and another element shown in the accompanying drawings. Therefore, when used, the terms for spatial relations may be applied to directions different from those shown in the accompanying drawings. Obviously, although all of these terms for spatial relations refer to the directions shown in the accompanying drawings for ease of explanation, a person skilled in the art will appreciate that directions different from those shown in the drawings may be used.

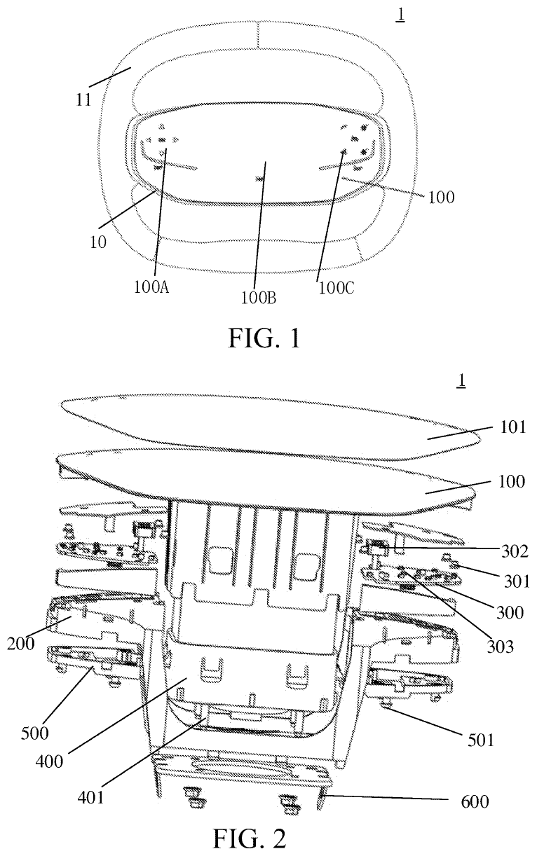

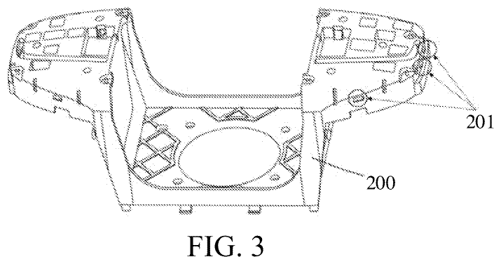

FIG. 1 schematically illustrates, in the front view, a steering wheel according to an embodiment of the present invention. FIG. 2 schematically illustrates, in an exploded view, the steering wheel according to the embodiment of the present invention. FIG. 3 schematically illustrates a support in the steering wheel according to the embodiment of the present invention. The steering wheel according to the embodiment of the present invention will be described below with reference to FIGS. 1 to 3.

As shown in FIGS. 1 to 3, the steering wheel 1 according to the embodiment of the present invention comprises a steering wheel central portion 10 and a steering wheel rim 11. In the embodiment shown in FIG. 1, the steering wheel rim 11 is provided as a complete ring shape, the steering wheel central portion 10 is provided as a strip shape, and the strip-shaped steering wheel central portion 10 extends to both sides in the length direction thereof until both ends thereof reach the steering wheel rim 11. Therefore, the steering wheel rim 11 is arranged to surround the steering wheel central portion 10. Of course, the complete ring steering wheel rim 11 shown in FIG. 1 is merely an example, the steering wheel rim of the present invention is not limited thereto, and the steering wheel rim may be provided as other shapes according to needs.

In view of FIG. 2, the steering wheel central portion 10 comprises a cover 100 and a support 200, and the cover 100 is connected to the support 200 in a suspended manner.

For example, the suspension connection is achieved by using the following means:
(1) as shown in FIG. 3, the support 200 is provided with hook-shaped portions 201, the hook-shaped portions 201 are provided at the edges of both sides in the length direction of the support 200, a plurality of hook-shaped portions 201 are provided on the edges of the support 200, correspondingly, a side wall (shown in FIG. 2) of the cover 100 is provided with window portions (not shown), and the hook-shaped portions 201 are provided to extend into the window portions of the cover 100 so that the cover 100 is snapped on the support 200; and
(2) the elastic units 301 (in particular, rubber) are provided between the cover 100 and the support 200.

By using the means described in (1) and (2) above, a certain gap is maintained between the cover 100 and the support 200, thereby allowing a slight movement of the cover 100 relative to the support. Therefore, a suspension connection between the cover 100 and the support 200 is achieved. Of course, the steering wheel of the present invention is not limited to the suspension connection between the cover and the support which is achieved by using the means described in the above example. For example, the window portions may be provided on the support, and the hook-shaped portions may be provided on the cover.

Further, the cover 100 and the support 200 together define an installation space in which the functional module is arranged, and a predetermined function provided in the functional module can be enabled/disabled by touching the cover 100.

As an example, as shown in FIG. 1, the cover 100 is divided into a middle region 100B, and a first side region 100A and a second side region 100C located on both sides of the middle region 100B. Also, as shown in FIG. 3, the support 200 is generally U-shaped, and has a middle portion that is recessed and two side portions that are higher than the middle portion, and the aforementioned hook-shaped portions 201 may be provided at the edges of the two side portions. The two side portions of the support 200 correspond to the first side region 100A and the second side region 100C, respectively. The two side portions may be provided with functional modules, and the middle portion of the support 200 corresponds to the middle region 100B and may be provided with an airbag module. In FIG. 2, a housing 400 of the airbag module is shown, and printed circuit boards 300 of the functional modules and force sensors 303 and touch feedback modules 302 to be mounted on the printed circuit boards 300 are also shown. It can be understood that the force sensors 303 are used to detect the position and/or magnitude of a touch force applied on the cover 100; the predetermined function includes one or more among a horn function, a multimedia function, and an auto-cruise function; the predetermined function of the functional modules is enabled/disabled on the basis of the position and/or magnitude of the touch force detected by the force sensor 303; and the touch feedback modules 302 are used to provide feedback, such as vibration feedback, when the predetermined function is enabled/disabled. The suspension connection between the cover 100 and the support 200 is particularly beneficial for configuring the vibration feedback.

Of course, the functional module may be provided only at a portion of the support 200 corresponding to the first side region 100A, or only at a portion of the support 200 corresponding to the second side region 100C.

In the present invention, as shown in FIGS. 1 to 3, the cover 100 is provided as a seamless cover, and the support 200 is provided as an integrated support.

In the present invention, the seamless cover is combined with the integrated support:

On the one hand, it is ensured that the support for supporting the cover has sufficient strength so that the cover is not damaged by being unable to be strongly supported when the cover is subjected to a force by a driver.

Therefore, the present invention provides a steering wheel that is stable and reliable when subjected to a force. In particular, a cover of the steering wheel is stably supported without wobbling when touched by the driver to enable/disable a corresponding function by means of a touch switch, and the strength of a member for supporting is sufficient without causing the cover to be damaged.

On the other hand, the support provides a consistent installation reference for each element in the airbag module, the functional module, etc., which, in combination with the provision of the seamless cover, ensures that the joint gap of the cover of the steering wheel has a uniform and symmetrical appearance.

As an example of the present invention, elastic units 301 are provided between both side portions of the support 200 and the cover 100, and no elastic unit 301 is provided between the middle portion of the support 200 and the cover 100. Since the integrated support provides a consistent installation reference for each element in the airbag module, the functional module, etc., the elastic units 301 distributed on both side portions of the support 200 can transmit pressing on the middle region 100B of the cover 100 to the first side region 100A and the second side region 100C to then be detected by the force sensors, which satisfies the pressing transmission and resetting consistency of the cover 100 in the first side region 100A, the middle region 100B, and the second side region 100C. Generally, the steering wheel 1 further comprises a steering wheel body (not shown) at which a steering column is to be connected and which is fixed to the steering wheel rim by means of spokes.

The steering wheel according to the embodiment of the present invention will be described in more detail below with reference to FIGS. 2 and 3.

As shown in FIG. 2, the steering wheel central portion 10 further comprises a connecting plate 600 and a rear cover 500. The connecting plate 600 and the rear cover 500 are located between the support 200 and the steering wheel body, the connecting plate 600 is used for connecting the support 200 and the housing 400 of the airbag module to the steering wheel body, and the rear cover 500 is used for connecting the support 200. Specifically, the first fixing member 401 is provided as a bolt which passes through a through hole at the bottom portion of a housing 401 of the airbag module, and passes through a through hole on the support 200 and a through hole on the connecting plate 600 at the middle portion of the support 200. The above-described housing 401, support 200 and connecting plate 600 are fixed together by means of nut fitting, and the connecting plate 600 is fixed to the steering wheel body at left and right side walls thereof (for example, by means of a bolt-and-nut assembly). Moreover, the support 200 is connected to the rear cover 500 by means of a second fixing member (for example, a screw) at a portion in which the functional module is provided. The bottom surface of the rear cover 500 is provided with mushroom-shaped protrusions 501, and the mushroom-shaped protrusions 501 are fixed into the foam body of the steering wheel rim 11 to connect the rear cover 500 and the steering wheel rim 11 together. Thus, the support 200 is fixed to the steering wheel rim 11 and the steering wheel body.

As an example, as shown in FIG. 2, a decorative layer 101 may be provided on the surface of the cover 100 to provide a desired appearance.

As described above, although the exemplary embodiments of the present invention have been described with reference to the accompanying drawings in the description, the present invention is not limited to the aforementioned specific embodiments, and the scope of protection of the present invention should be defined by the claims and equivalent meanings thereof.

1. A steering wheel the steering wheel being used for a vehicle and comprising:
a steering wheel central portion and a steering wheel rim surrounding the steering wheel central portion, the steering wheel central portion comprising a cover; and a support the cover being connected to the support in a suspended manner, and the cover and the support together defining an installation space in which a functional module is arranged, wherein a predetermined function provided in the functional module can be enabled/disabled by touching the cover,
wherein:
the cover is a seamless cover, and the support is an integrated support.

2. The steering wheel according to claim 1, wherein elastic units are provided between the cover and the support.

3. The steering wheel according to claim 2, wherein the cover is divided into a middle region and a first side region and a second side region located on both sides of the middle region, the functional module is provided at a portion of the support corresponding to the first side region or the second side region, and an airbag module is provided at a portion of the support corresponding to the middle region.

4. The steering wheel according to claim 3, wherein the steering wheel further comprises a steering wheel body fixed to the steering wheel rim by means of spokes,
the steering wheel central portion further comprises a connecting plate and a rear cover located between the support and the steering wheel body, the support is fixed to the connecting plate by means of a first fixing member at the portion in which the airbag module is provided, the connecting plate is fixed to the steering wheel body, and
the support is connected to the rear cover by means of a second fixing member at the portion in which the functional module is provided, and the rear cover is fixed to a foam body of the steering wheel rim.

5. The steering wheel according to claim 4, wherein the first fixing member is provided as a bolt-and-nut assembly and the second fixing member is provided as a screw.

6. The steering wheel according to claim 5, wherein the rear cover is provided with mushroom-shaped protrusions for fixing into the foam body.

7. The steering wheel (according to claim 1, wherein the support is provided with hook-shaped portions and the hook-shaped portions are provided to extend into a window portion of the cover so that the cover is snapped on the support

8. The steering wheel according to claim 1, wherein the functional module comprises touch feedback modules, and the touch feedback modules comprise a vibration feedback device provided on the cover for providing vibration feedback when the predetermined function is enabled/disabled.

9. The steering wheel according to claim 3, wherein the elastic units are configured as a plurality of pieces of rubber distributed on both a portion of the support corresponding to the first side region and a portion of the support corresponding to the second side region

10. The steering wheel according to claim 1, wherein the functional module comprises printed circuit boards fixed to the support force sensors are provided on the printed circuit boards to detect the position and/or the magnitude of a touch force applied to the cover; the predetermined function comprises one or more among a horn function, a multimedia function, and an auto-cruise function; and the predetermined function of the functional module is enabled/disabled on the basis of the position and/or the magnitude of the touch force detected by the force sensor.
